(19) United States
(12) Patent Application Publication
(10) Pub. No.: US 2005/0201488 A1
(43) Pub. Date: Sep. 15, 2005

(54) Display of digital interface symbol information from an analog signal

(76) Inventors: Christopher P. Duff, Colorado Springs, CO (US); Richard Douglas Eads, Colorado Springs, CO (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/799,139

(22) Filed: Mar. 12, 2004

(51) Int. Cl. H04L 27/06

(52) U.S. Cl. 375/316

(57) ABSTRACT

A system and method for displaying digital interface symbol information from at least one analog signal is provided. The digital interface symbol information includes encoded symbols as well as decoded information the encoded symbols represent. First, a set of data samples of the analog signal is captured at a frequency at least as high as the switching rate of the analog signal. The set of data samples is then converted into a serial bit stream by way of either a provided or extracted clock. The serial bit stream is searched for one or more sync symbols identified with the particular encoding scheme employed in the digital interface. Using the sync symbols, the encoded symbols in the serial bit stream are identified. At least some of the digital interface symbol information, such as the encoded symbols and the decoded information, are then correlated and displayed with a trace of the analog signal.

### BACKGROUND OF THE INVENTION

As digital electronics technology progresses, high-speed digital serial interfaces or busses become more popular in computer and communications systems.

Many of these busses, including Fibre Channel, Serial Advanced Technology Attachment (Serial ATA), Serial Attached Small Computer Systems Interface (Serial Attached SCSI, or SAS), and Gigabit Ethernet, employ an analog signal carrying digital information that is transmitted over a communications channel. The channel may be comprised of an electrically conductive wire or optical link between discrete electronic devices or between portions within a single device, or may exist as a wireless communications link.

Often, such a serial interface will employ an 8-bit/10-bit (8b/10b) encoding scheme. Under such a scheme, the analog signal switches between two distinct voltage levels, thereby representing a stream of binary digits, or bits. In this case, the frequency of the switching of the analog signal is the data rate of the bit stream represented by the analog signal. These bits form 10-bit symbols, some of which are data codes, which represent decoded 8-bit data bytes. Other 10-bit symbols are command codes, which present various command and signaling information onto the communications channel. This 8b/10b encoding scheme results in serial data being transmitted over the channel that is self-clocking in nature. After transmission, the embedded clocking information is extracted, and the 10-bit data codes are decoded to their original 8-bit data bytes for use by the receiving circuit. The 10-bit command codes are utilized to further interpret the data codes received via the channel.

The 8b/10b encoding scheme provides at least two primary advantages desirable in serial data communication. For example, the self-clocking nature of the encoding, which provides significant signal transition density, allows relatively simple clock recovery. Another advantage of the 8b/10b scheme is that a properly encoded serial bit stream exhibits direct-current (DC) balance, in that the number of ones and zeros remain substantially equal over even short portions of the stream. This DC balance is an asset in both fiber optic and electromagnetic wire physical interfaces, which often have difficulty properly detecting ones and zeros on DC-imbalanced data streams.

More information on 8b/10b encoding scheme can be obtained from a variety of sources, including the PCI Express™ Base Specification, Revision 1.0a, published Apr. 15, 2003 (see Section B, “Symbol Encoding,” p. 411, Table B-1), and Serial ATA: High Speed Serialized AT Attachment, Revision 1.0a, published Jan. 7, 2003 (see Section 7.2, “Encoding Method,” p. 129), both of which are hereby incorporated herein by reference.

When circuit designs implementing an 8b/10b-based communications interface are first being tested, or “debugged,” signal protocol problems or data corruption can be difficult to diagnose. Oftentimes, problems with the integrity of the associated analog signal are the root cause of such maladies. In such cases, the digital oscilloscope, with its ability to sample an analog voltage signal very quickly and to store many data samples at one time, provides an appropriate vehicle which an electronics designer can utilize to test an 8b/10b-based interface. However, oscilloscopes typically do not provide digital interface information or similar data that would aid the designer in understanding the symbols being transmitted over the interface. As a result, designers are normally required to manually interpret the analog signal captured by the oscilloscope in order to decipher the results in an attempt to determine the cause of a particular problem.

As a result, given the foregoing discussion, a need currently exists for extracting and displaying useful 8b/10b symbol information from an analog signal to improve the ability of an electronics designer to debug problems associated with such an interface. The means for satisfying that need may also be applied to other digital interfaces as well.

### SUMMARY OF THE INVENTION

Embodiments of the invention, to be discussed in detail below, provide a method for displaying digital interface symbol information from at least one analog signal. The digital interface symbol information includes encoded symbols and decoded information the encoded symbols represent. The method begins with capturing a set of data samples of the analog signal at a frequency at least as high as the switching rate of the analog signal. The set of data samples is then converted into a serial bit stream by way of a provided or extracted clock. The serial bit stream is then searched for one or more sync symbols of the particular encoding scheme involved. Using the sync symbols, the encoded symbols in the serial bit stream are identified. The resulting digital symbol information derived is displayed in a correlated fashion with a trace of the analog signal. A system for displaying digital interface symbol information from the analog signal is also provided.

Other aspects and advantages of the invention will become apparent from the following detailed description, taken in conjunction with the accompanying drawings, illustrating by way of example the principles of the invention.

### BRIEF DESCRIPTION OF THE DRAWINGS

FIG. 1 is a flow diagram of a method for displaying 8b/10b symbol information from an analog waveform according to an embodiment of the invention.

FIG. 2 is a sample oscilloscope display of 8b/10b symbol information correlated with an analog signal trace according to an embodiment of the invention.

FIG. 3 is a sample graphical user interface associated with an embodiment of the invention for allowing an oscilloscope user to specify search and trigger criteria for displaying an analog signal trace correlated with digital interface symbol information.

FIG. 4 is a block diagram of a system of displaying 8b/10b symbol information from an analog waveform according to an embodiment of the invention.

### DETAILED DESCRIPTION OF EMBODIMENTS OF THE INVENTION

Various embodiments of the invention, described herein, allow 8b/10b protocol and data information encoded into an analog signal to be displayed and time-correlated with the analog signal, typically on a display device associated with a digital oscilloscope. Such a display device may be integrated with the oscilloscope, a separate monitor coupled with the oscilloscope, a separate monitor associated with a personal computer coupled with the oscilloscope, and so on. A display of the analog signal juxtaposed with the 8b/10b information aids the designer in visualizing where within the analog signal any problems in the protocol information and decoded data lie, allowing the designer to more quickly and readily determine the ultimate source of any errors encountered.

Embodiments of the present invention are discussed below in conjunction with a digital oscilloscope. However, other electronics test and measurement devices that are not specifically termed oscilloscopes may provide similar functionality, such as sampling an analog waveform digitally for ultimate display for the user, and thus may also be employed in conjunction with embodiments of the invention.

Furthermore, the analysis of other digital interfaces, both serial- and parallel-oriented, may benefit from alternate embodiments of the invention based on the principles expressed below regarding embodiments associated with the 8b/10b encoding scheme. For example, embodiments of the invention related to the I2C (Inter-Integrated Circuit) interface, SPI (Serial Peripheral Interface), CAN (Controller Area Network), 4b/5b encoding, gray codes, and other schemes may be employed using the disclosed principles.

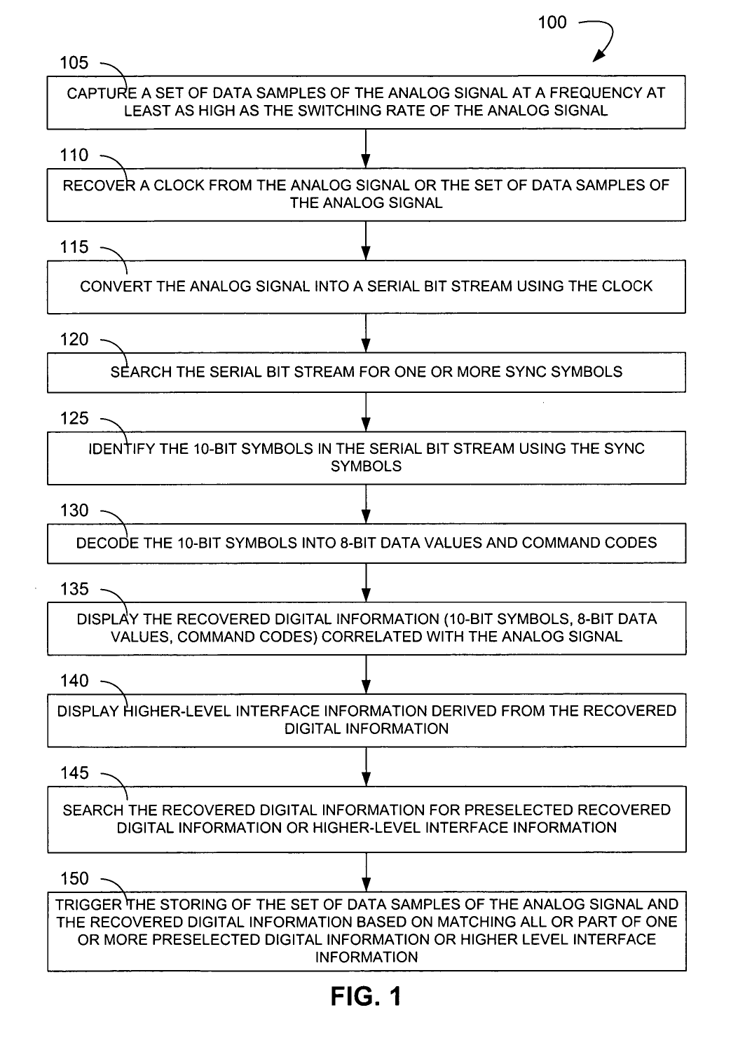

A high-level flow diagram describing a method 100 according to an embodiment of the invention is presented in FIG. 1. First, a set of data samples of the analog signal is captured at a frequency at least as high as the switching rate of the analog signal (step 105). Typically, however, the sampling frequency of the oscilloscope would be several times higher than the switching rate to ensure capture of all encoded data bits being transferred over the interface, as well as to capture any unintended transitions in the analog signal that may cause problems in the decoding of the transmitted data. Modem digital oscilloscopes typically allow many such samples to be captured at a high frequency in a single acquisition. For example, at 20 gigasamples per second, using an oscilloscope with a memory depth of 1 megasample, a total of approximately 125,000 data bits, or about 12,500 8b/10b symbols, of a 2.5 gigahertz (GHz) 8b/10b analog signal may be captured, resulting in a sampling rate of eight times the switching frequency of the analog signal.

By logical extension, embodiments associated a parallel (multi-bit) interface would involve a plurality of analog signals being captured and processed in a manner akin to that described herein for a single analog signal associated with a serial interface, such as one employing the 8b/10b encoding scheme.

Once the data samples have been captured, the clock associated with the 8b/10b symbols on the analog signal is recovered (step 110). This clock may be derived either directly from the analog signal, or from the captured data samples. The clock may take the form of an electronic signal generated by hardware during the recovery process. Alternately, the clock may be represented by a list of clock locations that are generated by a software clock recovery algorithm, with each clock location being a point in time relative to the set of data samples of the analog signal. As a result, several different methods available from the prior art for recovering the clock may be employed, depending on the circumstances involved.

For example, a first- or second-order analog hardware phase-locked loop (PLL), residing either within or external to the oscilloscope, may be used. Alternately, a digital hardware PLL, often employing a fast read-only memory (ROM) to both generate the clock while adjusting the frequency of that clock based on changes in the analog signal, may be utilized. Also, a software PLL may be used, such as that which is the subject of U.S. patent application Ser. No. 10/391,908 by Dennis J. Weller and Steve D. Draving, entitled APPARATUS AND METHOD FOR CLOCK RECOVERY AND EYE DIAGRAM GENERATION, filed on Mar. 19, 2003, assigned to Agilent Technologies, Inc., which is hereby incorporated herein by reference.

Other methods, such as constant frequency clock recovery, may be employed as well. In this mode, the best-fit frequency and phase of the clock are determined automatically by the oscilloscope. In alternate embodiments, the user may specify the frequency, leaving the oscilloscope to determine the best-fit phase. In both cases, a linear regression algorithm may be employed to determine the best-fit phase or frequency, although other methods from the prior art may be used as well. Also, such algorithms are typically realized in software, although hardware implementations, such as a field-programmable gate array (FPGA), may also be provided.

Ordinarily, the method used to recover the clock is substantially similar to that expected to be employed by a typical receiver of the analog signal. However, any of the aforementioned methods, or others from the prior art not herein described, may be implemented to recover the clock. Additionally, interfaces other than those employing the 8b/10b scheme, such as I2C (Inter-Integrated Circuit) and SPI (Serial Peripheral Interface), provide an explicit clock, thereby eliminating the necessity of separate clock recovery by the oscilloscope. Still others may explicitly provide a method of clock recovery specific to a particular interface.

Next, the recovered clock is then used to convert the data samples into a serial bit stream (step 115). Typically, this conversion is accomplished by reading each captured sample that aligns with a transition of the recovered clock, and then comparing each captured sample to some threshold value to determine whether that captured sample represents a binary one or zero. Alternately, a two-threshold system may be implemented, whereby captured samples over a ‘high’ threshold may be viewed as a one, those under a ‘low’ threshold would be deemed a zero, and those lying between the high and low thresholds would represent an invalid state of the analog signal. Such an invalid state would indicate some problem with the transmitting circuit or the communication channel involved, thereby providing the designer with additional information regarding the functionality of the communications channel.

Once the serial bit stream is generated, the stream is searched for one or more synchronization (“sync”) symbols (step 120) so that the boundaries of each 10-bit encoded symbol may be identified (step 125). Alternately, the serial bit stream may be segmented into 10-bit words while the stream is searched for sync symbols, with a subsequent realignment of the 10-bit word boundaries occurring after the sync symbols have been found. Sync symbols, referred to in 8b/10b terminology as K28.1, K28.5, and K28.7, represent a few of the command (‘K’) codes available for signaling purposes, as opposed to the data codes (‘D’) used for the actual data to be transmitted. The sync symbols, representing the encoded data pattern 0011111XXX (the X's denoting ‘don't care’ bits), provide the receiver of the 8b/10b serial bit stream with a way of determining where each 10-bit code begins and ends. In some 8b/10b-related literature, these sync symbols are also referred to as “comma characters.”

Any search algorithm applicable to a serial stream of digital data may be employed to find one or more sync symbols among the encoded data bits. For example, the serial bit stream may be searched starting at the beginning using a 10-bit moving window that progressives toward the end of the captured data stream one bit at a time until a sync symbol is located. In some embodiments, this searching process may continue to identify other sync symbols located within the serial bit stream. Alternately, subsequent sync symbols may be ignored.

Assuming one or more sync symbols have been located, and the boundaries of the 10-bit symbols determined as a result, the 10-bit symbols may be decoded to their associated 8-bit data values and command codes (step 130). Decoding may progress both forward and backward in the data stream from a sync symbol. Also, if more than one sync symbol has been detected, the serial data stream may then be resynchronized on the basis of the additional sync symbols, if necessary. However, if no sync symbols have been located, proper decoding of the data stream is not likely to occur.

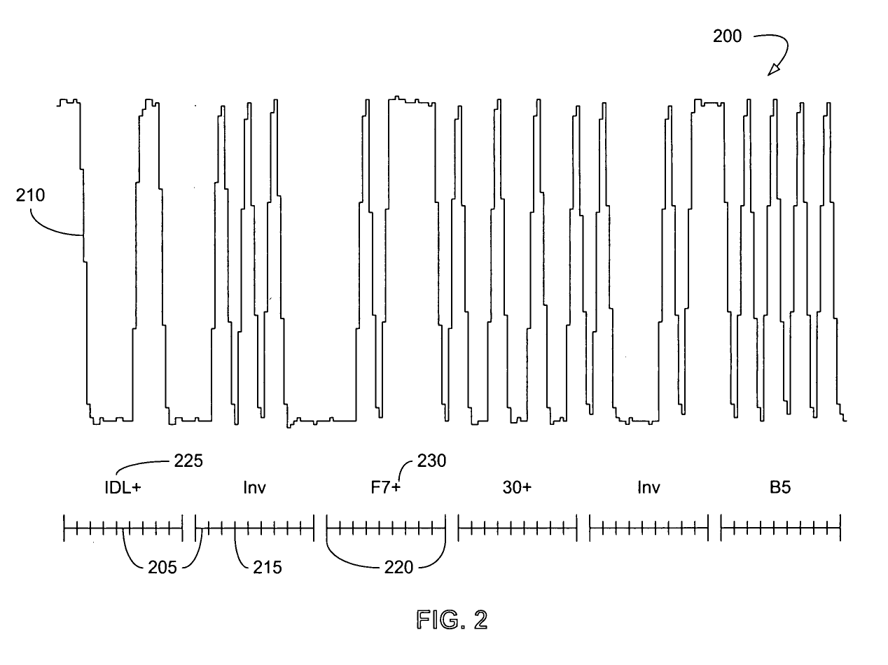

Once the encoded data stream has been decoded, the decoded data, as well as the encoded data stream, including both command and data codes, may be displayed in a correlated fashion with the set of data samples of the analog signal captured by the oscilloscope (step 135). Myriad ways of performing this step may be undertaken. In some embodiments, a graphical representation 200, as shown in FIG. 2, may be used for correlating the data samples and the analog signal. For example, horizontal line segments 205 plotted alongside a trace 210 of the analog signal carrying the encoded serial bit stream may be employed to indicate the duration of each 10-bit encoded symbol recovered from the analog signal as determined by the detected sync symbols. Additionally, small vertical line segments 215 intersecting each horizontal line segment 205 denote each recovered clock location within the associated 10-bit symbol. Furthermore, slightly longer vertical segments 220 may be utilized at the ends of each horizontal line segment 205 to further emphasize the beginning and end of each 10-bit symbol. Supplying this graphical information helps to indicate that both clock recovery and sync symbol detection have been successful. Conversely, the absence of this graphical information, or possibly the use of some other visual indication, would indicate that clock recovery or sync symbol detection had failed. For example, if the embedded clock had been recovered successfully, but no sync symbols had been found, the small vertical line segments 215 might be included in the display, but the horizontal line segments 205 may be omitted to indicate that synchronization with the 10-bit encoded symbols was not achieved.

Assuming synchronization has been achieved, symbol data and associated information may be displayed in a variety of ways. For example, 8-bit decoded data may be displayed as textual data 225 near the aforementioned horizontal line segments 205, as shown in FIG. 2. This data could be displayed in hexadecimal, decimal, binary, or some other format. Additionally, in some embodiments the format employed may be selectable by the user by way of an oscilloscope user interface, a personal computer, or other means.

Other methods of displaying the symbol data may be employed. In some cases, the user may desire that the encoded 10-bit data symbols be displayed, instead of the resulting decoded data. Once again, this data may be presented in several different numeric formats, such as hexadecimal, decimal, binary, and the like.

Alternately, as opposed to a straight numeric representation, the use of data byte names associated with the 10-bit encoded data as provided for in 8b/10b terminology may be beneficial to a certain class of users. Advantageously, this particular format could be used to identify both data codes (e.g., D11.7, D13.7, etc.) and command codes (e.g., K28.2, K23.7, etc.), which would be especially helpful information for those users intimately familiar with the details of the 8b/10b scheme.

Furthermore, user-defined labels may be employed in addition to, or in lieu of, the above-mentioned numeric representations. For example, as discussed previously, the sync symbols used to demarcate the boundaries of the 10-bit encoded symbols may thus be marked as “sync” or “comma.” Other terms more familiar to the particular user may also be programmed by the user into the oscilloscope to relate to a particular 10-bit encoded symbol to facilitate understanding by the user, thus enhancing the user's ability to debug problems with the communication channel involved.

Given the nature of a scheme that encodes 8-bit user data values into 10-bit symbols, several potential 10-bit symbols do not represent either data codes or valid command codes, thus being “invalid.” Regardless of the format in which the 8b/10b data is presented, these invalid 10-bit encoded symbols may be indicated graphically or textually, such as by the ‘Inv’ indication shown in FIG. 2. Such information is invaluable to the designer in determining the cause of invalid symbols over the communication channel involved.

Additionally, disparity information may be included in the 10-bit symbol display. In 8b/10b parlance, disparity normally is the difference between the number of ones and the number of zeros across the length of a 10-bit symbol. Typically, while many valid 10-bit symbols have a disparity of zero, several exhibit a disparity of plus or minus 2. For those cases, an 8b/10b encoder must keep track of the current running disparity so that a proper choice between two encoded alternatives may be made when selecting between a command or data code exhibiting a positive or negative disparity in order to maintain DC balance. In some embodiments of the invention, a disparity indicator 230, such as a ‘+’ or ‘−’, may be appended to the indicators employed for valid 10-bit symbols, as shown in FIG. 2, to indicate a plus 2 or minus two disparity related to that symbol. Additionally, other displayed indicators may be used to indicate the total disparity exhibited by a stream of 10-bit symbols captured by the oscilloscope in order to give the designer an indication of how well DC balance is being maintained.

Typically, the temporal relationship of the symbol information with the analog signal trace 210 is maintained in digital memory within the oscilloscope. As a result, repositioning of the symbol information with the trace 210 whenever the user of the oscilloscope scrolls or otherwise alters the display of the trace 210 is simply a matter of presenting symbols that are stored in a different location within that memory.

As mentioned above, the 8b/10b encoding scheme is often used as a lower-level communications ‘physical’ standard in a variety of higher-level communications protocols, such as Fibre Channel, Serial ATA, Serial Attached SCSI, Gigabit Ethernet, and so one. Therefore, once all appropriate 8b/10b symbol information has been recovered, information specific to the particular higher-level interface involved may then be displayed in conjunction with, or in lieu of, the 8b/10b symbol information described earlier, depending on the needs of the designer (step 140). For example, many such interfaces employ blocks of multiple symbols to define certain interface “primitives,” which denote particular commands, functions, status, and so forth involving the operation of the interface. Additionally, some interfaces may consist of multiple layers of such interface protocols, one stacked upon the other in a fashion similar to that provide by the International Standards Organization Open Systems Interconnect (ISO/OSI) model. Thus, providing the ability to display information relevant to those multiple layers may be advantageous in some embodiments.

In order to provide a designer faster access to predefined points of interest in either the recovered 8b/10b symbol information, or the associated higher-level interface information that employs the 8b/10b encoding scheme, the oscilloscope may allow the designer to search the recovered digital information for specific 8b/10b symbols, interface primitives, and the like (step 145). This capability frees the designer from having to look through all of the captured data for a particular event of interest. For example, if a particular higher-level command consistently fails, the designer is likely to want to search the captured data for that particular event, or some other related event, in order to determine the cause of the failure.

Additionally, an oscilloscope employing various method embodiments of the present invention may also allow triggering of the storing of the captured data samples of the analog signal and the associated 8b/10b symbols based on matching all or part of one or more symbols preselected by the user with the digital interface symbol information (step 150). This functionality allows the oscilloscope to discard portions of the serial bit stream and the captured data samples of the analog signal so that more of the data that is of interest to the user may be collected and perused.

Furthermore, the triggering function may also reposition the preselected 8b/10b symbols and the associated data samples of the analog signal at a specified point on the oscilloscope display, such as “time zero.” This functionality allows corresponding data for each instance of the trigger to occur at the same position on the display for comparison purposes.

Additionally, multilevel triggers, which allow the user to set more complex triggering conditions in order to capture extremely specific events on the communications channel involved, may also be implemented in a like manner. Also, the repositioning functionality of the trigger, often performed in software, may operate as a second-level trigger after a hardware trigger has been used to qualify a waveform for acquisition. In other words, after the hardware trigger has resulted in the capture of a set of data samples, the software trigger may search for a desired pattern, which if found may then be repositioned so that the point of interest is placed at time zero.

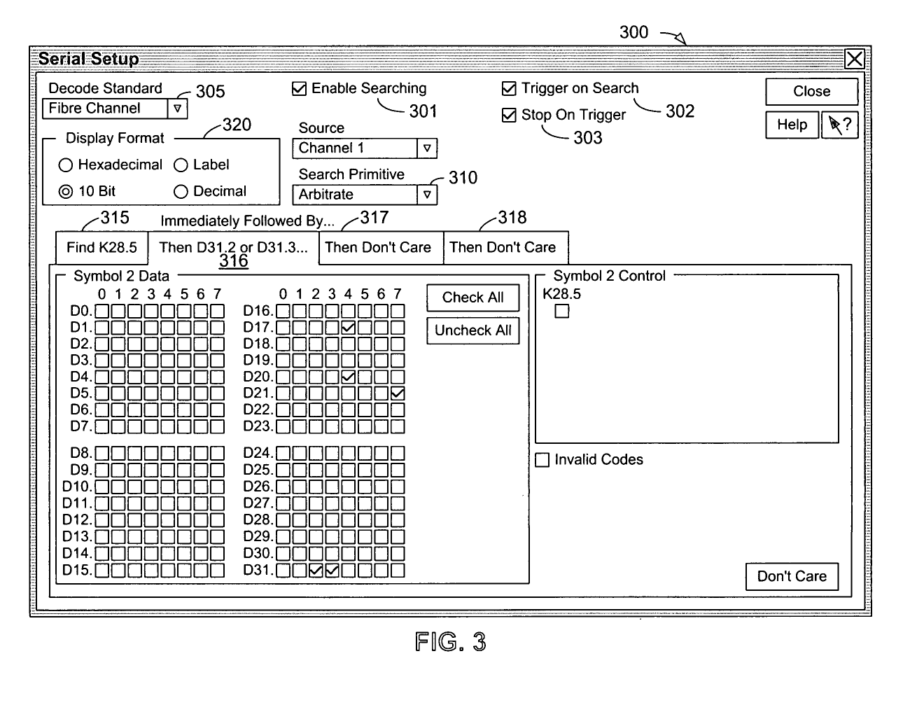

FIG. 3 displays a sample graphical user interface 300 for controlling the searching and triggering functions mentioned above. Searching, triggering the display based on that search, and stopping the collection of data after triggering are enabled by the user via three checkboxes 301, 302, 303. The searching and triggering functions are further specified by way of the remainder of the graphical user interface 300. For example, the user is provided a decode standard pull-down menu 305 to define a high-level interface employing the 8b/10b encoding scheme. In this case, the Fibre Channel interface has been selected. A primitive of that interface (in the example of FIG. 3, ‘Arbitrate’) can be selected as a matching criterion for a search of the interface data by way of a search primitive pull-down menu 310. Once this primitive has been found, the oscilloscope is directed to search for a series of 10-bit command and data codes in 8b/10b format. This process is indicated by the four tabbed serial search criteria 315, 316, 317 and 318, shown below the “Immediately Followed By . . . ” text. As defined by the user, command code K28.5, one of the sync symbols define above, is to be found as denoted under tab 315, followed by at least one of several data codes, such as D31.2, indicated under tab 316. As shown in the second search criteria 316, the setting of the search conditions is facilitated by providing checkmark boxes for each possible symbol arranged in separate data (‘Symbol 2 Data’) and control (‘Symbol 2 Control’) sections, as well as invalid codes.

The last two search criteria 317, 318 are set as “don't care,” and thus do not contribute any further requirements to the search.

Also shown in FIG. 3, the format in which the search criteria may be specified by the user is selectable by way of a display format window 320 via radio buttons. In this particular case, the 10-bit format of the 8b/10b scheme has been selected, but decimal, hexadecimal, and symbol label formats are also available.

Some of these functions, such as the searching and triggering functions described above, are normally provided by other forms of electronic test equipment, such as logic analyzers and protocol analyzers, which process and present data residing primarily in the digital realm. However, by providing such functionality within an oscilloscope that allows perusal of the analog signal in digitized form, graphically correlated with the digital information the analog signal represents, various embodiments of the invention allow significant advantages in troubleshooting heretofore unknown.

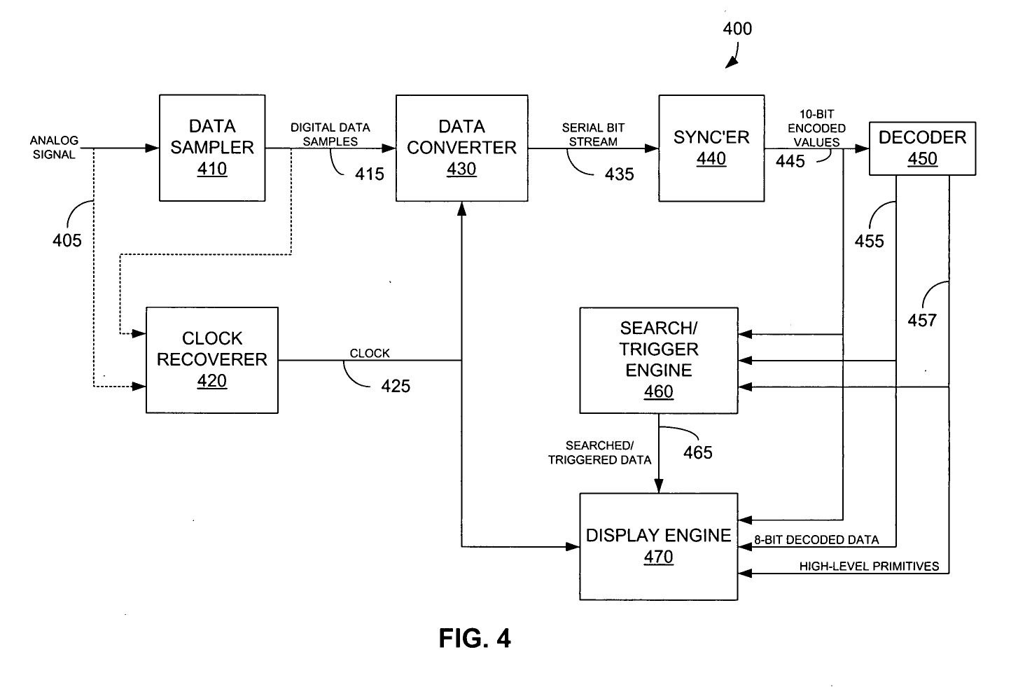

In addition to the methods noted above, embodiments describing a system for extracting and displaying 8b/10b symbol information from an analog signal are also presented. For example, a system 400 according to an embodiment of the invention, as shown in FIG. 4, provides such extraction and display in accordance with the methods discussed earlier. Such a system, portions of which may be implemented in software or electronic hardware, such as an FPGA, resides within a larger oscilloscope or similar device (not shown) and works cooperatively with the other components of that device.

In the system 400, a data sampler 410 takes as input an analog signal 405 carrying 8b/10b encoded data. In alternate embodiments, other encoding schemes, as described above, may also processed. The data sampler 410 generates a set of digital data samples 415 from the analog signal 405, as mentioned earlier. A clock recoverer 420 then takes either the analog signal 405 or the set of digital data samples 415 as input in order to generate a clock 425. According to the foregoing discussion, the clock 425 may either be a clock signal or a list of locations generated by a software clock recovery algorithm associated with the set of digital data samples 415. Additionally, the clock recoverer 420 may use any of the clock recovery methods, such as a hardware or software PLL, as described in detail above.

Using the clock 425, a data converter 430 then converts the set of digital data samples 415 to a serial bit stream 435. A synchronizer 440 then takes the serial bit stream 435 to identify the embedded sync symbols to produce properly-aligned 10-bit encoded values 445, which are then processed by a decoder 450 to generate decoded 8-bit data values and command codes 455 represented by the 10-bit encoded values 445. Additionally, the decoder 450 may generate primitives 457 associated with a high-level interface. These two streams of data, along with the 10-bit encoded values 445, may then be processed by a search/trigger engine 460 which provides the user with searching and triggering capabilities according to the discussion presented above, resulting in searched/triggered data 465 associated with encoded, decoded, and high-level interface data. The searched/triggered data 465, along with the 10-bit encoded data values 445, the decoded 8-bit data values and command codes 455, high-level interface primitives 457, and the clock 425 are then visually presented for the user by way of a display engine 470 that displays that data in correlation with a trace of the analog signal 405 in any of a number of ways as described above.

From the foregoing, embodiments of the invention provide a system and method for extracting and displaying 8b/10b symbol information from an analog waveform. Although several embodiments of the present invention have been discussed, specific embodiments other than those shown above are also possible. As noted earlier, information regarding other serial and parallel physical digital interfaces may be correlated with the associated analog signal or signals implementing that interface. As a result, the invention is not to be limited to the specific forms so described and illustrated; the invention is limited only by the claims.

1. A method for displaying digital interface symbol information from at least one analog signal, the digital interface symbol information including encoded symbols and decoded information, the method comprising:
capturing a set of data samples of the at least one analog signal at a frequency at least as high as the switching rate of the at least one analog signal;
converting the set of data samples into at least one serial bit stream using a clock;
searching the at least one serial bit stream for one or more sync symbols;
identifying the encoded symbols in the at least one serial bit stream using the sync symbols; and
displaying at least some of the digital interface symbol information with a representation of the at least one analog signal in a correlated fashion.

2. The method of claim 1, further comprising decoding the encoded symbols into the decoded information.

3. The method of claim 1, wherein the frequency of the capturing step is at least eight times as high as the switching rate of the at least one analog signal.

4. The method of claim 1, further comprising recovering the clock from the at least one analog signal, the clock being an electronic signal.

5. The method of claim 4, wherein the recovering step is accomplished by way of an analog hardware phase-locked loop (PLL).

6. The method of claim 4, wherein the recovering step is accomplished by way of a digital hardware PLL.

7. The method of claim 1, further comprising recovering the clock from the set of data samples, the clock being a list of locations in time relative to the set of data samples.

8. The method of claim 7, wherein the recovering step is accomplished by a software PLL.

9. The method of claim 1, wherein the digital interface symbol information displayed by the displaying step are encoded symbols.

10. The method of claim 2, wherein the digital interface symbol information displayed by the displaying step is decoded information.

11. The method of claim 1, wherein the encoded symbols comprise 10-bit symbols of an 8b/10b encoded interface.

12. The method of claim 2, wherein the decoded information comprises 8-bit data values and command codes of an 8b/10b encoded interface.

13. The method of claim 1, further comprising searching the digital interface symbol information for preselected symbol information.

14. The method of claim 1, further comprising triggering storage of the set of data samples based upon matching all or part of preselected symbol information with the digital interface symbol information.

15. The method of claim 14, wherein the triggering step also repositions the digital interface symbol information and the representation of the at least one analog signal to a specified point.

16. The method of claim 1, wherein the displaying step also displays high-level interface information derived from the decoded symbols with the representation of the at least one analog signal in a correlated fashion.

17. The method of claim 16, further comprising searching the high-level interface information for preselected symbol information.

18. The method of claim 16, further comprising triggering storage of the set of data samples based upon matching all or part of preselected symbol information with the high-level interface information.

19. The method of claim 18, wherein the triggering step also repositions the high-level interface information and the representation of the at least one analog signal to a specified point.

20. The method of claim 1, wherein the displaying step also displays at least one clock location with the representation of the at least one analog signal in a correlated fashion.

21. An electronic device employing the method of claim 1.

22. A system for displaying digital interface symbol information from at least one analog signal, the digital interface symbol information including encoded symbols and decoded information, the system comprising:
means for capturing a set of data samples of the at least one analog signal at a frequency at least as high as the switching rate of the at least one analog signal;
means for converting the set of data samples into at least one serial bit stream using a clock;
means for searching the at least one serial bit stream for one or more sync symbols;
means for identifying the encoded symbols in the at least one serial bit stream using the sync symbols; and
means for displaying at least some of the digital interface symbol information with a representation of the at least one analog signal in a correlated fashion.

23. The system of claim 22, further comprising means for decoding the encoded symbols into the decoded information.

24. The system of claim 22, wherein the frequency of the capturing means is at least eight times as high as the switching rate of the at least one analog signal.

25. The system of claim 22, further comprising means for recovering the clock from the at least one analog signal, the clock being an electronic signal.

26. The system of claim 22, further comprising means for recovering the clock from the set of data samples, the clock being a list of locations in time relative to the set of data samples.

27. The system of claim 22, wherein the digital interface symbol information displayed by the displaying step are encoded symbols.

28. The system of claim 23, wherein the digital interface symbol information displayed by the displaying step is decoded information.

29. The system of claim 22, wherein the encoded symbols comprise 10-bit symbols of an 8b/10b encoded interface.

30. The system of claim 23, wherein the decoded information comprises 8-bit data values and command codes of an 8b/10b encoded interface.

31. The system of claim 22, further comprising means for searching the digital interface symbol information for preselected symbol information.

32. The system of claim 22, further comprising means for triggering storage of the set of data samples based upon matching all or part of preselected symbol information with the digital interface symbol information.

33. The system of claim 32, wherein the triggering means also repositions the digital interface symbol information and the representation of the at least one analog signal to a specified point.

34. The system of claim 22, further comprising means for displaying high-level interface information derived from the decoded symbols with the representation of the at least one analog signal in a correlated fashion.

35. The system of claim 34, further comprising means for searching the high-level interface information for preselected symbol information.

36. The system of claim 34, further comprising means for triggering storage of the set of data samples based upon matching all or part of preselected symbol information with the high-level interface information.

37. The system of claim 36, wherein the triggering means also repositions the high-level interface information and the representation of the at least one analog signal to a specified point.

38. The system of claim 22, wherein the means for displaying also displays at least one clock location with the representation of the at least one analog signal in a correlated fashion.

39. A system for displaying digital interface symbol information from at least one analog signal, the digital interface symbol information including encoded symbols and decoded information, the system comprising:
a data sampler configured to capture a set of data samples of the at least one analog signal at a frequency at least as high as the switching rate of the at least one analog signal;
a data converter configured to convert the set of data samples into at least one serial bit stream using a clock;
a synchronizer configured to search for one or more sync symbols in the at least one serial bit stream for one or more sync symbols, and identify the encoded symbols in the at least one serial bit stream using the sync symbols; and
a display engine configured to display at least some of the digital interface symbol information with a representation of the at least one analog signal in a correlated fashion.

40. The system of claim 39, further comprising a decoder configured to decode the encoded symbols into the decoded information.

41. The system of claim 39, wherein the frequency of the capturing means is at least eight times as high as the switching rate of the at least one analog signal.

42. The system of claim 39, further comprising a clock recoverer configured to recover the clock from the at least one analog signal, the clock being an electronic signal.

43. The system of claim 39, further comprising a clock recoverer configured to recover the clock from the set of data samples, the clock being a list of locations in time relative to the set of data samples.

44. The system of claim 39, wherein the digital interface symbol information displayed by the displaying step are encoded symbols.

45. The system of claim 40, wherein the digital interface symbol information displayed by the displaying step is decoded information.

46. The system of claim 39, wherein the encoded symbols comprise 10-bit symbols of an 8b/10b encoded interface.

47. The system of claim 40, wherein the decoded information comprises 8-bit data values and command codes of an 8b/10b encoded interface.

48. The system of claim 39, further comprising a search/trigger engine configured to search the digital interface symbol information for preselected symbol information and trigger storage of the set of data samples based upon matching all or part of preselected symbol information with the digital interface symbol information.

49. The system of claim 48, wherein the search/trigger engine also repositions the digital interface symbol information and the representation of the at least one analog signal to a specified point.

50. The system of claim 39, further comprising a display engine configured to display high-level interface information derived from the decoded symbols with the representation of the at least one analog signal in a correlated fashion.

51. The system of claim 50, further comprising a search/trigger engine configured to search the high-level interface information for preselected symbol information and trigger storage of the set of data samples based upon matching all or part of preselected symbol information with the high-level interface information.

52. The system of claim 51, wherein the search/trigger engine also repositions the high-level interface information and the representation of the at least one analog signal to a specified point.

53. The system of claim 39, wherein the display engine also displays at least one clock location with the representation of the at least one analog signal in a correlated fashion.
